(19) United States
(12) Patent Application Publication
(10) Pub. No.: US 2006/0029461 A1
(43) Pub. Date: Feb. 9, 2006

(54) Ball joint assembly with wear indicating electrical circuit

(75) Inventors: Chester D. Benick, Lafayette, IN (US); Paul E. Jacobson, Lafayette, IN (US)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Automotive U.S. LLC

(21) Appl. No.: 10/912,409

(22) Filed: Aug. 5, 2004

(51) Int. Cl. F16C 11/00

(52) U.S. Cl. 403/122

(57) ABSTRACT

An improved ball joint assembly includes a ball stud having a head end portion which is at least partially enclosed by a housing. A contact member has an end portion which engages the head end portion of the ball stud prior to the occurrence of a predetermined amount of wear in the ball joint assembly. The contact member and head end portion of the ball stud are spaced apart upon the occurrence of the predetermined amount of wear in the ball joint assembly. Prior to the occurrence of the predetermined amount of wear in the ball joint assembly, an electrical circuit through the contact member and head end portion of the ball stud is closed. Upon the occurrence of the predetermined amount of wear in the ball joint assembly, the electrical circuit is opened.

### BACKGROUND OF THE INVENTION

The present invention relates to a ball joint assembly having an electrical circuit to indicate when a predetermined amount of wear occurs in the ball joint assembly.

A conventional ball joint assembly includes a housing which encloses a head end portion of a ball stud and a bearing. The head end portion of the ball stud is supported within the housing. A shank portion of the ball stud extends from the housing and is commonly rotatable and tiltable relative to the housing. During use, movement of the head end portion of the ball stud results in wear within the ball joint assembly, such as wear of the bearing. When wear within the ball joint assembly reaches a predetermined amount, the ball joint assembly should be replaced.

It is desirable to determine when wear of the predetermined amount occurs within the ball joint assembly. One ball joint assembly that indicates wear includes an electrical contact. Electrical power is applied to the electric contact and to the ball stud. When the predetermined amount of wear occurs, the ball stud engages the electric contact. When the ball stud engages the electric contact, an indicator device is energized to indicate wear of the predetermined amount. Ball joint assemblies constructed in this manner are disclosed in Japanese patent publication number 560069 A2 and in U.S. patent publication No. 2003/0070476 A1.

Another ball joint assembly includes a bearing member which is received in a socket structure and enables a ball stud to tilt relative to the socket structure. The bearing member is electrically conductive and provides an electrical connection between at least a portion of the socket structure and the ball stud. An electrically non-conductive biasing member is interposed between a portion of the socket structure and the bearing member. The biasing member urges the bearing member away from the portion of the socket structure such that, in response to a predetermined amount of wear within the ball joint assembly, the electrical connection between the portion of the socket structure and the ball stud is discontinued. A ball joint assembly having this construction is disclosed in U.S. patent application Ser. No. 10/251,393 filed Sep. 20, 2002 by Daniel E. Williams and entitled Ball Joint Assembly With Wear Indication.

### SUMMARY OF THE INVENTION

The present invention relates to a new and improved ball joint assembly having a housing which encloses the head end portion of a ball stud. An electrical contact member has an end portion which engages the head end portion of the ball stud prior to the occurrence of a predetermined amount of wear in the ball joint assembly. Upon the occurrence of the predetermined amount of wear in the ball joint assembly, the end portion of the contact member and the head end portion of the ball stud become spaced apart.

The contact member and the head end portion of the ball stud form a portion of an electrical circuit. The electrical circuit conducts electrical energy along a path extending through the contact member and the head end portion of a ball stud when the contact member is disposed in engagement with the head end portion of the ball stud prior to the occurrence of the predetermined amount of wear in the ball joint assembly. The electrical circuit is open when the end portion of the contact member and the head end portion of the ball stud are spaced apart upon the occurrence of the predetermined amount of wear in the ball joint assembly.

### BRIEF DESCRIPTION OF THE DRAWINGS

FIG. 1 is a schematic illustration of a ball joint assembly constructed in accordance with the present invention;

FIG. 2 is an enlarged schematic fragmentary view of a portion of the ball joint assembly of FIG. 1 prior to the occurrence of a predetermined amount of wear; and

FIG. 3 is a schematic fragmentary view generally similar to FIG. 2, of the ball joint assembly of FIG. 1 after the occurrence of the predetermined amount of wear.

### DESCRIPTION OF ONE SPECIFIC PREFERRED EMBODIMENT

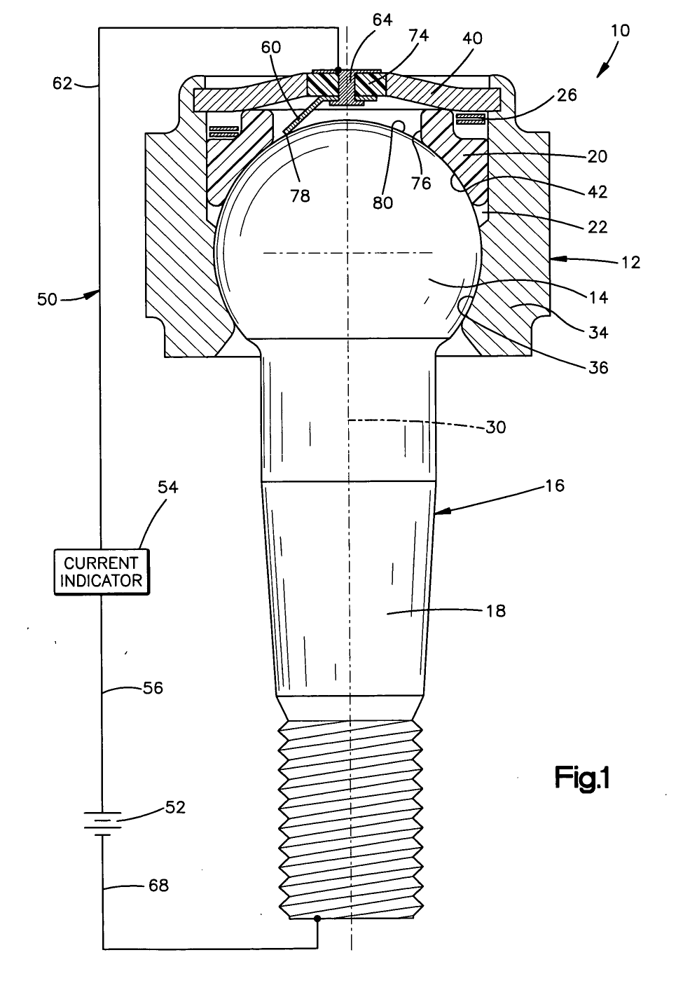

A ball joint assembly 10 (FIG. 1) includes a housing 12. The housing 12 encloses a head end portion 14 of a ball stud 16. The ball stud 16 includes a shank portion 18 which extends outward from the housing 12 and from the head end portion 14.

A bearing 20, formed of a suitable electrically insulating polymeric material, is disposed in a generally cylinderical socket chamber 22 in the housing 12. The bearing 20 has an annular cross sectional configuration and is disposed in engagement with the generally spherical head end portion 14 of the one piece metal ball stud 16. The bearing 20 is pressed against the head end portion 14 of the ball stud 16 by a bearing spring 26. In the embodiment of the invention illustrated in FIG. 1, the bearing spring 26 is an annular wave spring. The bearing spring 26 has a central axis which is coincident with a central axis 30 of the housing 12. The central axis 30 of the housing 12 is coincident with a central axis of the metal ball stud 16 when the ball stud is in the centered position illustrated in FIG. 1. It should be understood that the bearing spring 26 may have a different construction than the illustrated wave spring construction. For example, the bearing spring 26 may be a coil spring.

The ball stud 16 is tiltable from the central position illustrated in FIG. 1. Tilting of the ball stud 16 moves the central axis of the ball stud into a skewed relationship with the central axis 30 of the housing 12. In addition, the ball stud 16 may be rotatable about the central axis of the ball stud.

The housing 12 has a cylindrical metal wall section 34 which extends around the head end portion 14 of the ball stud 16. The wall section 34 has an arcuate metal bearing surface 36 having a center of curvature which is coincident with the center of the head end portion 14 of the ball stud 16. The arcuate bearing surface is formed as a portion of a sphere having the same diameter as the generally spherical head end portion 14 of the ball stud 16.

In addition to the wall section 34, the housing 12 includes a circular metal cover 40 which is fixedly secured to the metal wall section 34. The bearing spring 26 is disposed between the cover 40 and the annular bearing 20. The bearing spring 26 is effective to press an arcuate bearing surface 42 on the bearing 20 against the spherical head end portion 14 of the ball stud 16. The bearing surface 42 is formed as a portion of a sphere and has a center of curvature which is coincident with the center of curvature of the head end portion 14 of the ball stud 16. The wall section 34, bearing 20, bearing spring 26, and cover 40 are all disposed in a coaxial relationship with the central axis 30 of the housing 12 and are centered on the central axis 30.

In accordance with a feature of the present invention, a wear indicator circuit 50 FIG. 1 is provided to indicate when a predetermined amount of wear has occurred in the ball joint assembly 10. The wear indicator circuit 50 includes a voltage source 52. In the illustrated embodiment of the invention, the voltage source 52 is a battery. Of course other sources of voltage could be utilized if desired. The battery 52 is connected with a current indicator 54 by a lead 56.

The current indicator 54 is connected with a metal contact member 60 by a lead 62 and a metal terminal 64. The battery 52 is connected with the shank portion 18 of the metal ball stud 16 by a lead 68.

The wear indicator circuit 50 may form a portion of a vehicle in which the ball assembly 10 is disposed. Alternatively, the wear indicator circuit 50 may be part of a test apparatus which includes a probe to engage the terminal 64 and a second probe to engage the shank portion 18 of the ball stud 16. However, if desired, the two probes may be formed as a unitary structure. If this is done, one of the probes would engage the terminal 64 and the other probe would engage the shank portion 18.

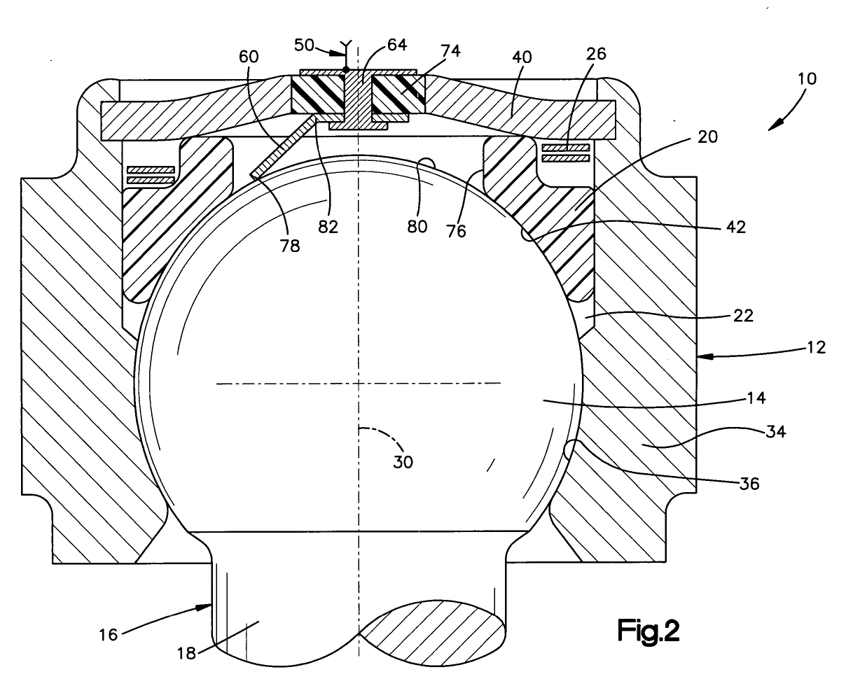

The contact member 60 is mounted on the cover 40 of the ball joint assembly 10. The contact metal member 60 and a metal terminal 64 are electrically insulated from the metal cover 40 by a circular body 74 (FIGS. 1 and 2) of electrically insulating material. The terminal 64 extends through an opening in the body of electrically insulating material and is connected directly to the contact member 60. The body 74 of electrically insulating material is effective to electrically insulate the contact member 60 and terminal 64 from the cover 40. If desired, the contact member 60 may extend through the body 74 of electrically insulating material and be connected to the lead 62.

The contact member 60 is formed of resilient spring metal which is electrically conductive. The contact member 60 extends through a circular central opening 76 in the bearing 20 into engagement with the head end portion 14 of the ball stud 16. Since the bearing spring 26 extends around the bearing 20, the contact member 60 also extends through a circular central opening in the bearing spring. The contact member 60 is a leaf spring which is resiliently deflected by engagement with the head end portion 14 of the ball stud 16.

When the cover 40 is to be mounted on the wall section 34 of the housing 12 during assembly of the ball joint assembly 10, the contact member 60 is resiliently deflected by engagement of an end portion 78 of the contact member with an outer side surface 80 of the head end portion 14 of the ball stud 16 (FIG. 2). During assembly, the contact member 60 deflects against the head end portion 14 of the ball stud 16 by an amount equal to a predetermined amount of wear. As the cover 40 (FIG. 2) is moved into position on the housing 12, the contact 60 resiliently flexes upward or in a clockwise direction about a bend 82. The amount of upward (as viewed in FIG. 2) movement of the end portion 78 of the contact member 60 corresponds to the predetermined amount of wear.

Also, during assembly the cover 40 engages the spring 26 to cause the spring to apply a downward bias, as viewed in the drawings, on the bearing 20 and the ball stud 16. The housing 12 is deformed against the upper (as viewed in the drawings) surface of the cover 40.

The outer side surface 80 of the head end portion 14 of the ball stud 16 forms a portion of a sphere. Therefore, when tilting and/or rotational movement occurs relative to the housing 12, the end portion 78 of the contact member 60 remains in engagement with the outer side surface of the head end portion 14 of the ball stud 16. As a result of tilting and/or rotational movement of the ball stud 16, the housing 12 may wear, for example at the bearing surface 36.

Upon the occurrence of wear in the ball joint assembly 10, the head end portion 14 of the ball stud 16 moves away from the cover 40 and contact member 60 due to the bias of spring 26 acting on the bearing 20. As this occurs, a small space forms between the end portion 78 of the contact member 60 and the outer side surface 80 on the head end portion 14 of the ball stud 16. As this space is formed, the wear indicator circuit 50 is opened.

Opening of the wear indicator circuit 50 provides an indication to the current indicator 54 that the predetermined amount of wear has occurred. The output from the current indicator 54 then indicates that the ball joint assembly 10 needs to be replaced. The wear indicator circuit 50 may continuously monitor the ball joint assembly 10 to determine when the predetermined amount of wear occurs. Alternatively, the wear indicator circuit 50 may be connected with the ball joint assembly 10 whenever it is desired to check the wear of the ball joint assembly.

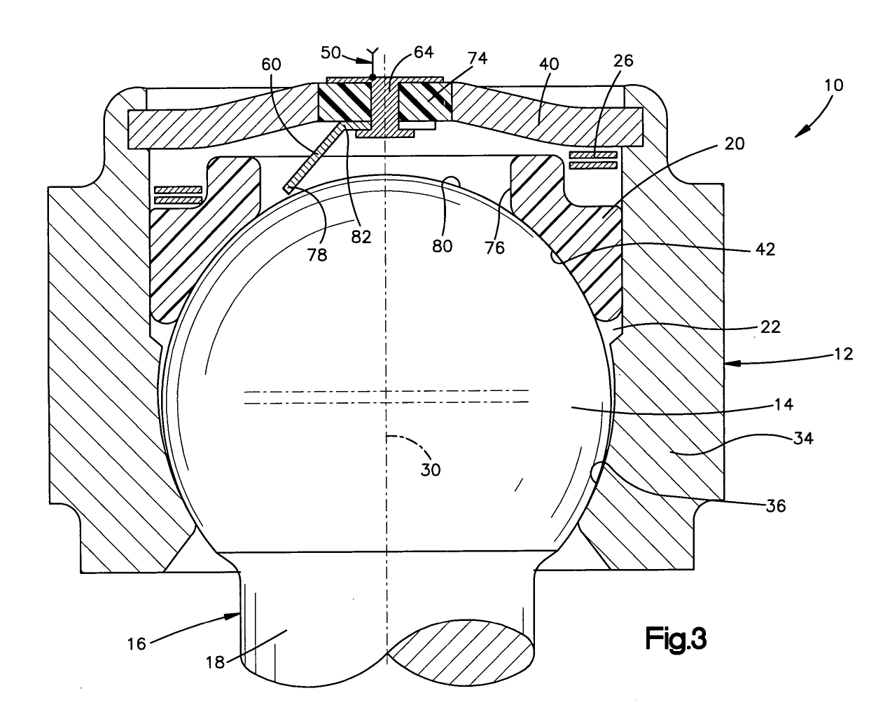

Prior to the occurrence of the predetermined amount of wear in the ball joint assembly 10, the end portion 78 of the contact member 60 is disposed in engagement with the outer side surface 80 on the head end portion 14 of the ball stud 16. At this time, the wear indicator circuit is closed. Thus, there is a continuous circuit along which electrical energy flows from the battery 52 through the current indicator 54, metal terminal 64 and metal contact member 60 to the head end portion 14 of the ball stud 16. Since the ball stud 16 is formed of metal (steel), electrical current flows through the ball stud 16 to the lead 68 and the battery 52. The wear indicator circuit 50 is maintained in a closed condition until the predetermined amount of wear, illustrated schematically in FIG. 3, occurs in the ball joint assembly 10.

During use of the ball joint assembly 10, the ball joint assembly will begin to wear due to tilting and/or rotation of the ball stud 16. As this occurs, the head end portion 14 of the ball stud 16 will tend to move downward from the initial position of FIGS. 1 and 2 toward the position indicated schematically in FIG. 3. As the ball joint assembly 10 wears, the bearing spring 26 applies force against the cover 40 and the bearing 20 to press the bearing against the head end portion 14 of the ball stud 16. During an initial relatively small amount of wear of the ball joint assembly 10, the end portion 78 of the resilient contact member 60 remains in engagement with the outer side surface 80 of the head end portion 14 of the ball stud 16. This is because the contact member 60 is resiliently deflected during assembly of the ball joint assembly 10.

As wear occurs in the ball joint assembly 10 and the head end portion 14 of the ball stud 16 moves downward (as viewed in FIGS. 2 and 3) away from the cover 40, the resiliently deflected contact member 60 gradually straightens. When the predetermined amount of wear occurs in the ball joint assembly 10, a slight gap is formed between the end portion 78 of the contact member 60 and the outer side surface 80 on the head end portion 14 of the ball stud 16. This slight gap is effective to open the wear indicator circuit 50.

In the illustrated embodiment of invention, the contact member 60 is formed of a resilient metal which is electrically conductive. However, it is contemplated that the contact member 60 may have a different construction if desired. For example the contact member may be formed as a metal plunger which is partially enclosed by a sleeve and is pressed against the head end portion 14 of the ball stud 16 by a spring which is enclosed by the sleeve.

From the above description of the invention, those skilled in the art will perceive improvements, changes, and modifications. Such improvements, changes, and modifications within the skill of the art are intended to be covered by the appended claims.

Having described the invention, the following is claimed:

1. A ball joint assembly comprising:
a housing;
a ball stud having a head end portion which is at least partially enclosed by said housing; and
a contact member at least partially disposed in said housing and having an end portion which engages said head end portion of said ball stud prior to the occurrence of a predetermined amount of wear in said ball joint assembly, said end portion of said contact member and said head end portion of said ball stud being spaced apart upon the occurrence of the predetermined amount of wear in said ball joint assembly;
said contact member and said head end portion of said ball stud form a portion of said an electrical circuit which conducts electrical energy along a path extending through said contact member and said head end portion of said ball stud when said end portion of said contact member is disposed in engagement with said head end portion of said ball stud
prior to the occurrence of the predetermined amount of wear in said ball joint assembly, said electrical circuit being open when said end portion of contact member and said head end portion of said ball stud are spaced apart upon the occurrence of the predetermined amount of wear in said ball joint assembly.

2. A ball joint assembly as set forth in claim 1 wherein said contact member includes a second end portion connected with a body of electrically insulating material which is connected with said housing.

3. A ball joint assembly as set forth in claim 1 further including a bearing member which engages said head end portion of said ball stud, said contact member extends through said bearing member into engagement with said head end portion of said ball stud prior to the occurrence of the predetermined amount of wear in said ball joint assembly.

4. A ball joint assembly as set forth in claim 1 further including a bearing disposed in engagement with said head end portion of said ball stud, and a spring which is disposed within said housing and presses said bearing against said head end portion of said ball stud, said contact member extends through said spring and said bearing into engagement with said head end portion of said ball stud prior to the occurrence of the predetermined amount of wear in said ball joint assembly.

5. A ball joint assembly as set forth in claim 1 wherein said electrical circuit includes a source of voltage and an indicator which is responsive to opening of said electrical circuit upon the occurrence of the predetermined amount of wear in said ball joint assembly;

6. A ball joint assembly comprising:
a housing;
a ball stud having a head end portion which is at least partially enclosed by said housing; and
an electrical contact member, said contact member having a bias causing closure of an electrical circuit which includes a portion of said ball joint assembly;
said contact member and said portion of said ball joint assembly form an electrical circuit which conducts electrical energy along a path extending through said contact member and said portion of said ball joint assembly when said contact member is biased into engagement with said portion of said ball joint assembly prior to the occurrence of a predetermined amount of wear in said ball joint assembly, said electrical circuit being open when said contact member and said portion of said ball joint assembly are spaced apart upon the occurrence of the predetermined
amount of wear in said ball joint assembly and said bias is eliminated.
